(19) United States
(12) Patent Application Publication
(10) Pub. No.: US 2024/0094561 A1
(43) Pub. Date: Mar. 21, 2024

(54) Inkjet Colorization and Imaging System for Eyewear Lenses

(71) Applicants: Yen-Ting Wu, Tainan (TW); Tien-Shu Wu, Tainan (TW)

(72) Inventors: Yen-Ting Wu, Tainan (TW); Tien-Shu Wu, Tainan (TW)

(21) Appl. No.: 18/368,537

(22) Filed: Sep. 14, 2023

Related U.S. Application Data
(60) Provisional application No. 63/407,572, filed on Sep. 16, 2022.

(51) Int. Cl. G02C 7/10; B41J 3/407; B41M 3/00

(52) U.S. Cl. CPC G02C 7/10; B41J 3/407; B41M 3/003

(57) ABSTRACT

A colorized lens for eyewear is provided using nozzles emitting ink to form colors and images and the like in an image layer upon the lens. A viewing area is formed within the image to provide a view through a single color layer area or an area of no imaging ink, to eliminate images and lines thereof from the view of a wearer of the lens.

This application claims priority to U.S. Provisional Patent application Ser. No. 63/407,572 filed on Sep. 16, 2022, which is incorporated herein in its entirety by this reference thereto.

### FIELD OF THE INVENTION

The present device relates to the formation of eyewear lenses, such as those for sunglasses, goggles, and spectacles. More particularly, the system and method herein relate to the formation of color and images on such eyewear lenses through the employment of an inkjet or spray nozzle printing for formation of colorized layers upon the lenses.

### BACKGROUND OF THE INVENTION

The formation of lenses for eyewear, such as eyeglasses, sunglasses and goggles, frequently includes the positioning of multiple layers of optically correct material where each functions to filter light or reflect light or both filter and reflect light communicated to and through the formed lens. For example and in no way limiting, optically correct layers are engaged to lenses which include a hard coat to help prevent scratching and abrasion, an anti-fog coating to help prevent moisture related fogging, a mirror coating to reflect a portion of light at a particular color or wavelength, and anti-reflective coatings to minimize reflections such as on the side of the lens viewed by the user. Most such coatings are applied using either films which are configured to the purpose or vacuum deposition or immersion. This employment of film and coatings significantly increases the time for forming such lenses where multiple layers are overlain and also causes a significant increase in the overall cost of lens production due to the significant time required.

The forgoing examples of conventional multilayer lens formation and different coatings and layers and the like are intended to be illustrative and not exclusive, and they do not imply any limitations on the lens coating invention described and claimed herein. Various other limitations of the related art are known or will become apparent to those skilled in the art upon a reading and understanding of the specification below and the accompanying drawings.

### SUMMARY OF THE INVENTION

The system and method herein disclosed provides for the formation of colorized layers, reflective layers and/or images and the like on lenses employed for eyeglasses, goggles, safety shields, and spectacles and the like. Through the employment of inkjet or pressurized nozzle-deposited inks upon lenses, a significant reduction in the time required to form colored and reflective layers. Further, virtually any image can be imparted to lenses thereby allowing for a significant increase in the ability for customization of lenses.

The system herein employs a primer layer which is imparted to cover one or both sides of the lens to be employed for eyewear, such as sunglasses or goggles and the like. The primer layer material, when cured, is substantially optically correct and transparent wherein the optics of the lens itself are not impacted.

The positioning of this primer layer on the polymeric or glass material forming the eyewear lens is preferred to ensure that the ink composition imparted to the lens to form colorization and images and the like in a colorized layer on the lens, adheres strongly to the underlying substrate of polymeric or glass lens material. While the ink formulation forming the colorized layer may be adjusted to increase adherence, an underlying primer layer is preferred. Without the positioning of the primer layer upon the lens substrate, additionally applied layers such as the colorized layer, hard coatings, anti-fog coatings, mirror coatings, and/or anti reflective coatings, are subject to peeling and dismounting should the bottom layer of ink peel or dismount from the polymeric or glass lenses.

By the term primer herein is meant a water based primer material formed primarily of water, EB Glycol Ether, and N-Methyl-2-Pyrrolidone (NMP) with an index of refraction between 1.0 and 2.0 with a current favored material being a material such as CrystalCoat PR-670 having an index of refraction of substantially 1.5 as manufactured by SDC Technologies of Irvine, California. Another preferred primer is CrystalCoat PR-765 formed of water and Ethylene Glycol Mono Butyl Ether, also from SDC Technologies. However, other primer as would be employed by those skilled in the art may be used and is anticipated within the scope of this patent. Any primer layer noted herein may be sprayed upon the lens but more preferably may be dip coated or flow coated upon the lens either under or over an ink layer.

The term ink, as used herein, is intended to include not only any ink adapted to flow through and from an inkjet type nozzle which may include transparent dye or pigment-containing materials, but any flowable substance or composition which can be mixed and configured for application to the primer layer and/or lens substrate surface for forming colors, indicia, symbols, characters or patterns thereon. Further, such inks currently employ preferred solvent type inks with volatile organic compounds (VOCs) and UV curable inks and the like.

Additionally meant by the term ink are a jet ink composition which includes, in addition to a particulate pigment material and a solvent composition, a resin composition. The current preferred resin composition includes an uncured silicone resin, an uncured epoxy resin, and an uncured melamine resin. Upon a thermal cure, the uncured resin composition, a cured resin composition is formed with superior adhesion to substrates such as but not limited to glass substrates, ceramic substrates and metal oxide substrates. Currently, ink from 3MACJET Technology in Taiwan is employed with excellent results.

The colorized layer herein is created using a computer controlled spray/inkjet process. The formation of the colorized layer is not invasive like the traditional tint process where the color/ink forming a colorized layer is inset or formed inherent into the lens material. Instead the colorized layer created, using the system herein, is formed much like a coating which, using conventional methods and materials, will not adhere sufficiently to be sold as a lens product.

To achieve this advanced and enhanced adhesion of the nozzle-deposited colorized layer good adhesion thereof must occur, or it will have the same defects conventional attempts of forming colorized layers on lenses such as peeling during consumer use. The advanced adhesion of this colorized layer, enabling the use of computer-controlled inkjet printers or nozzles, is achieved using a mixture of individual amounts of ink, dye, and specific resin mix using multiple resins.

The use of the formulated ink composition herein, for forming the colorized layer upon lenses, with adherence substantially equal to or superior to that using the above noted conventional method, replaces the need for vacuum deposition and other time consuming means for forming a colorized layer on the lens.

This formulated ink coating and method thereof, forming the colorized coated layer on the lens, are all predicated upon forming the ink composition best suited to adhere to the substrate intended which preferably includes the noted primer layer. The ink composition varies depending on this substrate and primer composition and includes, in addition to a particulate ink pigment material such as those from 3MAC company of Taiwan, a solvent composition and a resin composition. This resin composition includes an uncured silicone resin, an uncured epoxy resin, and an uncured melamine resin.

Upon thermal curing of the ink composition, the uncured resin in the ink composition, which defines the colorized layer, forms a cured resin composition with superior adhesion to substrates, such as, for example and in no way limiting, plastic or polymeric substrates, glass substrates, ceramic substrates, and metal oxide substrates. Thus, it is this ink composition, noted above, which significantly improves the adhesion of the colorized layer formed by the ink composition to thereby match or exceed colorized layers achievable by conventional means, such as vapor deposition and the like and at a fraction of the time.

Further, the ink composition herein can be deposited to the colorized layer using inkjet printers or other computer controlled nozzles. This allows for an infinite amount of colors, patterns, and other indicia to be easily formed in the colorized layer thereby allowing for shorter manufacturing time and more importantly a high degree of customization.

As noted, the colorized layer, formed by the cured ink composition mixture, has enhanced adhesion properties which can be increased using an underlying primer layer. Currently, a primer, which when cured to form an adhering primer layer on the underlying polymeric or glass lens which is substantially optically correct, is therefor preferred. For example only and in no way limiting, Crystal Coat PR-670 or Crystal Coat PR-765 from SDC Technologies of Irvine, California which can be applied by dip or flow coat, or Natron G1 Glass primer from Boston industrial solutions are examples of such primer material which may be deposited on lenses as a primer layer. Once cured, this primer material leaves a visually undetectable molecular coating on glass or polymeric or other substrate surface which has a very low refractive index and is adapted for strong adhesion of inks thereon.

As such, once this primer layer is properly applied to one or both sides of the lens, inks, employed for nozzle deposit on the substrate for colorized layers and images and the like, will achieve a strong bond to the lens. Thereafter, subsequent optical layers and coatings and additional primer coatings which attach to the transparent cured ink layer or layers will also maintain a strong bond to the lens.

Additionally, the method herein can employ inks and other liquid materials which may be operatively disbursed from an inkjet type nozzle and cured to thereby form any or all of the other noted sequentially applied coatings and layers. For example, coatings and layers, which in current conventional manufacturing are applied using film, immersion and/or vacuum deposition, can be applied using the inkjet technology herein, because the primary layer of such adjacent the lens substrate has achieved adhesion to the optically correct primer layer.

Particularly preferred, in all modes of the lens printing system herein, is the positioning of a determined viewing area through each lens through which the wearer of the lens will, or most likely will, be viewing. Once this determined viewing area is ascertained, any imaging printed to the lens by the nozzles may be adjusted to include no color or a single color within the substantially circular or oval viewing area.

Currently, a viewing area is ascertained from a pupillary distance of a wearer between two of the lenses. when worn. The approximate alignment of each pupil with the substrata or lens will then have preserved a substantially circular viewing area between 5 mm to 25 mm at least above, and preferably above and below, the center point of a diameter line running through and centered upon the determined pupil position. The horizontal line, currently, is between 15-25 mm in length and centered on the center point aligning with the pupil position. Currently, as shown herein, the viewing area has a curved perimeter edge surrounding the center point thereof, such that an upper and lower hemispheric area is formed.

The viewing area, thus, will only have a single color or no color therein, so the wearer sees an optically correct view through each eye, with no lines or images or dots or the like, which is aligned with a respective viewing area on each lens. Of course, the other coatings placed on top of the image, such as mirror or colorized coatings, will still have only a single color in the viewing area so that the wearer is not viewing through images.

This viewing area can be ascertained in advance for each lens wearer individually or by an estimate. It can be determined individually by having an optician or the wearer determine the pupillary distance of a wearer and then calculating where the center of each pupil on each lens will be located, once the lenses are in a frame on the head of the wearer. However, such a determined viewing area may also employ a pupillary distance determined to provide a center point for the viewing area for each lens by using an average pupillary distance for adults which is around 60-64 mm and using a computer model of the lenses being printed upon, as mounted within frames.

By a viewing area for each lens thus is meant herein, an area upon the substrate or eyewear lens, surrounding a center point thereof determined to substantially align with a pupil of the wearer of the lens when worn in frames. The viewing area is substantially at least 5 mm above and preferably also below the pupil-aligned center point and may extend sideways along a horizontal center line.

If images are printed within the viewing area, only a single color of ink is positioned within the viewing area from the printing of the images. The center of the perimeter of the viewing area, currently in a preferred range, is from 5 mm to 25 mm above the center point and curving to each side thereof. In an especially preferred mode, the viewing area will extend below the horizontal center line a substantially equal amount as above. Other coatings may be added thereafter so long as they are evenly applied in the viewing area.

As such, the viewing area is an important inclusion in the formation of the lenses herein and forming a viewing area within the printed image or images on each lens is especially preferred. Where artwork is supplied for the image printing on a lens, such will be adjusted to include the determined viewing area on each lens within the artwork.

With respect to the above description, before explaining at least one preferred embodiment of the method and system herein for inkjet positioning of colorization and imagery and indicia upon lenses in detail, it is to be understood that the invention is not limited in its application to the details of construction and to the arrangement of the components in the following description or illustrated in the drawings. The method for inkjet positioning of one or more layers upon eyewear lenses herein described and shown is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for imparting of colorized layers and indicia and imagery to eyewear lenses and for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements.

Thus, the phrase “consisting essentially of” indicates that the listed elements are required or mandatory, but that other elements are optional and may or may not be present depending upon whether or not they affect the activity or action of the listed elements. By “optically correct” is meant that there is little to no visual distortion to the lens or layer of material thereon when viewed through it, and the resulting eyewear lens substantially meets all industry and/or government standards for such a eyewear lens. Where used herein, if not otherwise defined, the term “substantially” means plus or minus five percent.

It is an object of the present invention to provide a system and method for the positioning of colorized layers upon lenses for eyewear using an ink composition yielding substantially transparent inks which are employable using inkjet type print heads or nozzles.

It is another object of the invention herein to provide an ink composition which forms such colorized layers on lenses which, using computer control of the nozzles, can also include imparting images, text, and other indicia to the lens.

It is yet another object of this invention to provide a system which employs an optically correct transparent primer layer to ensure that overlain colorized layers formed of an ink composition maintain strong adhesion to which sequentially applied films and coatings will also adhere.

It is a further object of this invention to insure that a wearer of the lenses is provided an optically correct viewing area within any imaging printed thereon, with for example no dots or uneven printing or visual interference in the viewing area. These and other objects, features, and advantages of the present inkjet colorization and imaging system for eyewear lenses, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed inkjet lens colorization and imagery system herein. It is intended that the embodiments and figures disclosed herein are to be considered illustrative of the invention herein, rather than limiting in any fashion.

In the drawings:

FIG. 1 is a depiction of an inkjet printhead having one or a plurality of inkjet nozzles which deposit the ink composition herein for a colorized layer and/or primer material layer upon a lens substrate.

FIG. 2 depicts one mode of sequentially forming an eyewear lens with multiple optical layers thereon using the system herein.

FIG. 3 shows another mode of sequentially forming an eyewear lens with multiple optical layers thereon using the system herein.

FIG. 4 depicts another mode of sequentially forming an eyewear lens with multiple optical layers thereon using the system herein.

FIG. 5 shows another mode of sequentially forming an eyewear lens with multiple optical layers thereon using the system herein.

FIG. 6 shows a further mode of sequentially forming an eyewear lens with multiple optical layers thereon using the system herein.

FIG. 7 depicts an additional mode of sequentially forming an eyewear lens with multiple optical layers thereon using the system herein.

FIG. 8 depicts the preferred positioning of a viewing area upon each lens and the surrounding multicolor areas where image printing may occur in multiple colors and images.

FIG. 9 shows examples of the colorizing layers the inkjet system herein provides wherein virtually any color combination or image or text or other indicia may be imparted to the lenses using the formulated ink composition.

### DETAILED DESCRIPTION OF THE INVENTION

In this description, the directional prepositions of up, upwardly, down, downwardly, front, back, top, upper, bottom, lower, left, right and other such terms refer to the positions of layers or components as they may be oriented and appear in the drawings and are used for convenience only and such are not intended to be limiting or to imply that the lenses or colorized layers have to be used or positioned in any particular orientation.

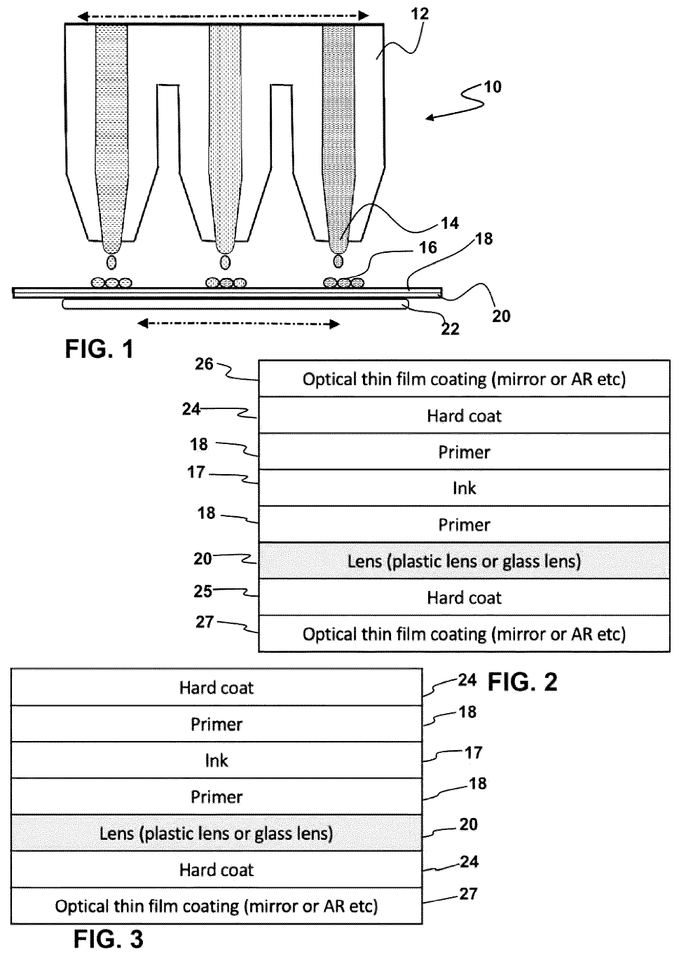

Now referring to drawings in FIGS. 1-9, wherein similar components are identified by like reference numerals, there is seen in FIG. 1 a depiction of the system 10 herein wherein an inkjet type printhead 12 which is operatively engaged to a computing device directing movement of a mount holding the printhead 12. The printhead 12 may have one or a plurality of inkjet nozzles 14 which deposit liquid material 16, such as ink, primer material, or other layer-forming material from the nozzles 14 and upon a substrate 20 which herein primarily means an eyeglass lens.

In particularly preferred modes of the system 10 herein, the primer material 18 is deposited upon the substrate 20 as a first layer where liquid 14, such as ink is to be formed on an immediately adjacent layer. The primer material 18, forming the primer layer on the substrate 20, as noted above, may be deposited on the substrate 20 using the nozzles 14 and printhead 12, or by dip coating the lens, or by flow coating the primer material on the substrate 20 such as an eyeglass lens. Alternatively, the eyeglass lense or substrate 20 may have such a primer layer 18 included thereon in manufacture.

It is the deposit of the primer material 18 and the using the ink composition noted herein, which must be positioned in a colorized layer using the nozzles 14 to provide the ability to form an infinite number of colors, color combinations, and indicia and the like.

Movement of the printhead 12 is controlled by a computer device having software thereon running to the task of moving the printhead 12, moving the support 22 for the substrate 20, or moving both singularly or concurrently. The movement of the printhead 12 and support 22 operate in a fashion to yield the layer or image or color or the like upon the substrate 20 material forming the eyewear lens, such as a polymeric material or glass.

For example, in the case of the colorized layer formed by the ink 17 composition, herein noted, the controlled movement of the printhead 12 and/or support 22 will cause the liquid material 16, in the form of the ink 17 formulation, to form a substantially even, uninterrupted colorized ink 17 layer from the cured ink formulation material. Also, by non limiting example, where an image or colorized or multicolor layer is formed by the emitted liquid material 16, such as in the form of the ink 17 composition (FIG. 11), one or both of the printhead 12 and support 22 can have computer controlled movements thereof to yield the desired image, indicia, or colorized layer. Such images or indicia or colorization can be from digital images or the like through which a computer controlling movements of the printhead 12 and/or support 22 will produce.

The system 10, employing software running on a computing device operating to the various tasks herein noted, can form eyewear lenses from the substrates 20 which have differing layers of material positioned sequentially thereon. Shown in FIG. 2 is one such mode of sequentially forming an eyewear lens with multiple optical layers thereon using the system 10 herein. As shown, the primer 18 material layer is engaged to the exterior side of the substrate 20 on the side opposite the eyes of the wearer. Upon the cured primer 18 layer is then positioned the ink 17 composition to form a colorized layer using the controlled movements by one or both of the printhead 12 and the support 22 for the substrate 20.

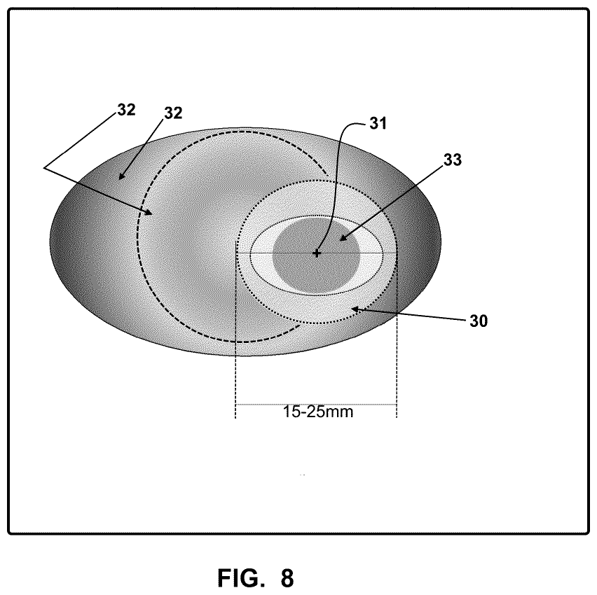

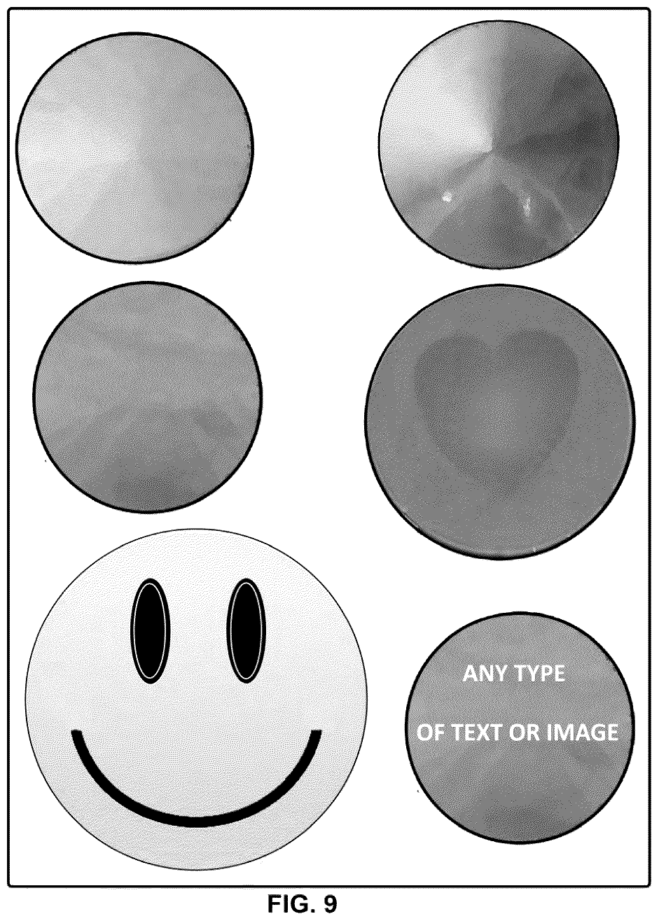

Subsequent to the positioning of the ink 17 composition, layers forming the color or image or indicia or the like, as in FIGS. 8-9 for example, another layer of primer 18 is positioned upon the ink 17 layer. This second layer of primer 18 provides a surface adapted to securely engage and hold an exterior hard coating layer 24. With this exterior hard coating 24 layer securely adhered to the primer 18 engaged to the ink 17 layer, an exterior film layer 26 can be securely engaged without fear of the ink 17 layer dismounting.

On the interior side of the substrate 20 is positioned an interior hard coating 25 and an interior film layer 27 which may be a mirror or anti-reflective coating similar to the exterior film layer 26. As noted herein, while denoted as an exterior or interior film coating 26 and 27, it is anticipated, with the employment of the primer 18 layers herein that these coatings can be formed by liquid material 16 adapted to such and emitted from the nozzles 14, or the coatings can be formed by immersion or other conventional means.

Another mode of the formation of the eyewear lens from the substrate 20 is shown in FIG. 3. As shown, a primer 18 layer is formed on the exterior side of the substrate 20 either using the liquid material 16 configured to form such a primer layer 18 emitted from the nozzles 14, or by forming such a primer layer 18 on the substrate 20 using an immersion coating or a flow coat or the like. Thereafter, the ink 17 composition forming the colorized layer is adhering to the primer 18 layer by the nozzles 14 emitting liquid material 16 in the form of the ink 17, in the composition noted, to form the colorized layer, image, indicia, or the like from the ink 17.

Because the ink 17 formulation herein cures the colorized layer, which will not peel easily, another or second primer 18 layer can be positioned on the cured colorized layer formed by the ink 17 composition, noted herein. This can be done using liquid material 16 from the printhead 12 configured for such or by employing the noted primer materials herein or their equivalent in a flow coat or immersion process. Thereafter, the exterior hard coating 24 layer is engaged upon the second primer 18 layer. On the interior of the substrate 20, forming the eyewear lens, an interior hard coating 25 is adhered to the substrate 20 and an interior film coating 27.

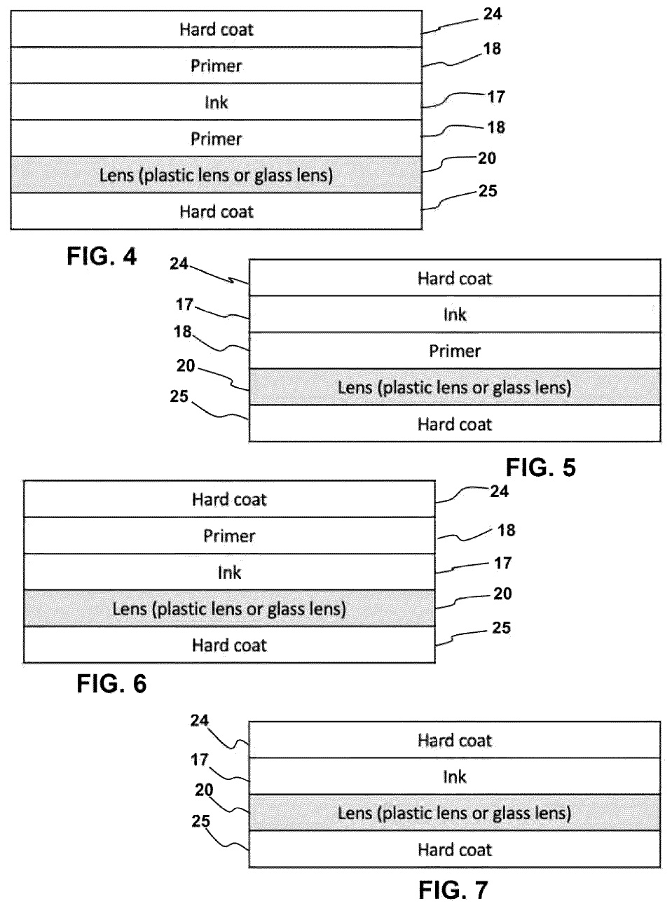

In FIG. 4 is shown another mode of sequentially forming an eyewear lens with multiple optically correct layers thereon using the system 10 herein. As shown, the transparent primer 18 layer is first formed by the noted primer material herein which is communicated onto the substrate 20 by flow coating, immersion, or where sprayable, by the nozzles 14. Thereafter, liquid material 16, in the form of the above noted transparent ink 17 composition, is communicated and adhered to the primer 18 layer by the nozzles 14. This allows for the formation of a colorized layer from the ink composition to thereby form colored layers, images, mixtures, rainbows, or indicia or the like for which the eyewear lens the substrate 20 will be used. On the interior side of the substrate 20 forming the lens is an interior hard coating 25.

In FIG. 5 is shown another mode of the sequential formed eyewear lens using the substrate 20. As shown, the primer 18 layer is formed either by the liquid material 16 from the nozzles 14 adapted to form the optically correct transparent primer 18 layer, or by immersion or flow coating or the like. Thereafter, the colorized layer formed of the ink 17 composition is applied using the liquid material 16 in the form of the ink 17 composition from the nozzles 14 of the printhead 12. Using the computer-controlled nozzle and/or platform movement and positioning, the colorized layer of an image, multiple colors, indicia, or the like can be easily positioned in a highly customizable fashion. Because the colorized layer formed by the ink 17 composition is securely engaged to the substrate 20 by the adherence thereof to the primer 18, the exterior hard coating 24 can be applied directly onto the colorized layer formed by the ink 17 composition, noted herein, without fear of a dismount. An interior hard coating 25 is shown engaged upon the interior surface of the substrate 20 forming the lens.

Shown in FIG. 6 is a further mode of sequentially forming an eyewear lens from the substrate 20 with multiple layers thereon using the system herein. As can be seen, the liquid material 16 from the nozzles 14 in the form of the transparent ink 17 composition herein, is applied to the exterior of the substrate 20. In this case, the ink 17 composition may have the transparent primer material included in the formulation of the ink 17 composition, or the composition mixture itself may be adjusted to aid in the secure adherence to the substrate 20 eyeglass lens.

Adhered upon the colorized layer formed by the sprayed ink 17 composition herein which, as noted, forms an infinite number of colors and/or images and/or indicia on the substrate 20 herein, such as in FIGS. 8-9, is a primer 18 layer to which the exterior hard coating 24 layer is engaged securely. An interior hard coating 25 is engaged directly to the substrate 20 forming the lens on the side facing the eyes of the wearer.

In FIG. 7 is shown an additional example of a mode of sequentially forming an eyewear lens from the substrate 20 with multiple optically correct layers thereon using the system herein. As shown, material 16 emitted from the nozzles 14 in the form of the transparent ink 17 composition will form a colorized layer of one or multiple colors and/or imagery and/or indicia, such as shown in FIGS. 8-9. This colorized layer is adhered to the lens substrate 20 on the exterior side thereof. The formed colorized layer from the nozzle-applied ink 17 composition, so deposited, may be adjusted in the mixture of the above noted composition or may include a portion of primer or some version thereof, to enhance the engagement of the colorized layer formed by the ink 17 composition. To the colorized layer, formed by the nozzle-deposited ink 17 composition, is added the exterior hard coating 24. On the interior surface of the substrate 20 is adhered the interior hard coating 25 layer.

In FIG. 8 is shown the preferred positioning of a viewing area 30 upon a substrate 20, such as an eyewear lens. The viewing area 30, as noted above, will surround a center point 31 determined to substantially align with a pupil of the eye 33 of the wearer. This viewing area 30 is preferably at least 15 mm in diameter horizontally to either side of the center point 31 and a current preferred range is 15 mm-25 mm with 20 mm being a current favorite as experimentation has shown such to provide optically correct viewing in a perceived single color for the lens wearer. Outside the viewing area 30 is a multicolor area wherein any imaging, colorization, or multicolor coatings and the like may be placed without interfering with the clear viewing by the user through the viewing area 30.

As noted, multiple layers of coatings and the like may be placed within the viewing area 30 so long as a single evenly disbursed color or no color is placed within the viewing area 30. As noted, layers of hard coat 24 or primer 18 or ink 17 may be placed within the viewing area 30 so long as they produce an even or single color therein which has not lines or dots or overlays and the like which would interfere with vision of the wearer therethrough. Where digital images or artwork are used to produce the images or colors or the like on the substrate 20, such as an eyeglass lens, it will be adjusted, if necessary, to allow only a single color of ink 17 therein. Any other layers of hardcoat 24 or primer 18 or ink 17 will also have an even single color whereby the view through the viewing area 30 for the user will appear as a conventional lens or sunglass lens with an even single color perception to the wearer.

In FIG. 9 is shown some non limiting examples of the substantially infinite colorization and indicia and imagery which the system herein provides during the formation of eyewear lenses from lens substrate 20 material. As noted, using the inkjet type printer or printer head 12 an/or computer-controlled movement spray nozzle, liquid material 16 in the form of the ink 17 composition noted is employable to form one or multiple colors in the colorized layer. While not depicted in the all of the example substrate lenses in FIG. 9, a viewing area 30 would be included where necessary to provide the user with substantially optically correct viewing through the eyeglass lens or substrate 20.

The employment of inkjet or computer-controlled nozzle printing of such indicia and imagery in a colorized layer formed by the ink composition herein significantly enhances the speed of lens formation with such. Further, because the formed indicia and colors and the like on the substrate 20 is performed by nozzles 14 such as those from a computer-controlled printhead 12, virtually any image or color or color combination can be easily formed on each substrate 20. This enables easy customization of each substrate 20 for color and design of the eyewear lens to that desired by the buyer, without any slowing of the manufacturing process since all of the lenses are formed in that fashion.

It should be noted that any of the different depicted and described configurations of the inkjet imparted images and layers for eyewear lenses herein, can be employed with any other configuration or component shown and described as part of the device herein. Additionally, while the present invention has been described herein with reference to particular embodiments thereof and/or steps in use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A colorized lens for eyewear comprising:
a substrate forming a lens, said lens having a first surface opposite a second surface;
an image layer, said image layer comprising a single or multicolor image upon said first surface of said substrate by nozzles emitting ink therefrom to form said image layer; and
a layer of hardcoat material positioned upon said image layer.

2. The colorized lens for eyewear of claim 1 additionally comprising:
a viewing area formed within said image layer, said viewing area having a single color of said ink or having no said ink therein; and
whereby a wearer of said lens is provided said viewing area having a single color or no color therein for viewing through said lens.

3. The colorized lens for eyewear of claim 1 additionally comprising:
a layer of primer material positioned in between said image layer and said layer of hardcoat material.

4. The colorized lens for eyewear of claim 2 additionally comprising:
a layer of primer material positioned in between said image layer and said layer of hardcoat material.

5. A colorized lens for eyewear comprising:
a substrate forming a lens, said lens having a first surface opposite a second surface;
a first layer of primer material positioned upon said first surface;
an image layer, said image layer comprising a single or multicolor image upon said first layer of primer material by nozzles emitting ink therefrom to form said image layer.

6. The colorized lens for eyewear of claim 5 additionally comprising:
a layer of hardcoat material positioned upon said image layer.

7. The colorized lens for eyewear of claim 5 additionally comprising:
a second layer of primer material positioned upon said image layer; and
a layer of hardcoat material positioned upon said second layer of primer material.

8. The colorized lens for eyewear of claim 7 additionally comprising:
an optical thin film coating positioned upon said layer of hardcoat material.

9. The colorized lens for eyewear of claim 5 additionally comprising:
a viewing area formed within said image layer, said viewing area having a single color of said ink or having no said ink therein; and
whereby a wearer of said lens is provided said viewing area having a single color or no color therein for viewing through said lens.

10. The colorized lens for eyewear of claim 6 additionally comprising:
a viewing area formed within said image layer, said viewing area having a single color of said ink or having no said ink therein; and
whereby a wearer of said lens is provided said viewing area having a single color or no color therein for viewing through said lens.

11. The colorized lens for eyewear of claim 7 additionally comprising:
a viewing area formed within said image layer, said viewing area having a single color of said ink or having no said ink therein; and
whereby a wearer of said lens is provided said viewing area having a single color or no color therein for viewing through said lens.

12. The colorized lens for eyewear of claim 8 additionally comprising:
a viewing area formed within said image layer, said viewing area having a single color of said ink or having no said ink therein; and
whereby a wearer of said lens is provided said viewing area having a single color or no color therein for viewing through said lens.

13. A method of imparting an image upon a lens for eyewear comprising:
positioning a lens adjacent one or a plurality of ink emitting spray nozzles;
imparting an image upon a first surface of said lens facing said spray nozzles using ink emitted therefrom; and
forming a viewing area within said image layer, said viewing area having a single color of said ink or having no said ink therein; and
whereby colored image is formed upon said first surface having said viewing area providing a wearer a view through a single color area of said image or a view through said viewing area having no color therein.

14. The method of imparting an image upon a lens for eyewear of claim 13, additionally comprising:
calculating a center point of said lens which aligns with the pupil of said wearer; and
forming said viewing area around said center point.

15. The method of imparting an image upon a lens for eyewear of claim 14, additionally comprising:
forming said viewing area in a substantially circular shape around said center point having a diameter of said viewing area between 15-25 mm.
